(19) United States
(12) Patent Application Publication
(10) Pub. No.: US 2017/0352344 A1
(43) Pub. Date: Dec. 7, 2017

(54) LATENT-SEGMENTATION INTONATION MODEL

(71) Applicant: Semantic Machines, Inc., Berkeley, CA (US)

(72) Inventors: Taylor Darwin Berg-Kirkpatrick, Berkeley, CA (US); William Hui-Dee Chang, San Leandro, CA (US); David Leo Wright Hall, Berkeley, CA (US); Daniel Klein, Orinda, CA (US)

(73) Assignee: Semantic Machines, Inc., Berkeley, CA (US)

(21) Appl. No.: 15/428,828

(22) Filed: Feb. 9, 2017

Related U.S. Application Data
(60) Provisional application No. 62/345,622, filed on Jun. 3, 2016.

(51) Int. Cl. G10L 13/10; G10L 13/033; G10L 13/027

(52) U.S. Cl. CPC G10L 13/10; G10L 13/0335; G10L 13/027; G10L 2013/105

(57) ABSTRACT

The intonation model of the present technology disclosed herein assigns different words within a sentence to be prominent, analyzes multiple prominence possibilities (in some cases, all prominence possibilities), and learns parameters of the model using large amounts of data. Unlike previous systems, intonation patterns are discovered from data. Speech data is sub-segmented into words, the different segments are analyzed and used for learning, and a determination is made as to whether the segmentations predict pitch

### CROSS REFERENCE TO RELATED APPLICATIONS

This application claims the priority benefit of U.S. provisional patent application Ser. No. 62/345,622, titled “Latent Segmentation Intonation Model,” filed, Jun. 3, 2016, the disclosure of which is incorporated herein by reference

### SUMMARY

Despite advances in machine translation and speech synthesis, prosody—the pattern of stress and intonation in language—is difficult to model. Several attempts at solving issues related to prosody have been to account for speech intonation, but these attempts have failed to provide speech synthesis that sounds natural. The intonation model of the present technology disclosed herein assigns different words within a sentence to be prominent, analyzes multiple prominence possibilities (in some cases, all prominence possibilities), and learns parameters of the model using large amounts of data. Unlike previous systems, intonation patterns are discovered from data. Speech data is sub-segmented into words, the different segments are analyzed and used for learning, and a determination is made as to whether the segmentations predict pitch. Prominence within a sentence may be assigned using word positions and/or prominent syllables of words as markers in time. The markers are linked, indicating what the prominence should be, and parameters of the model are learned from large amounts of data. The intonation model described herein may be implemented on a local machine such as a mobile device or on a remote computer such as a back-end server that communicates with a mobile application on a mobile device.

### BRIEF DESCRIPTION OF FIGURES

FIG. 1A is a block diagram of a system that implements an intonation model engine on a device in communication with a remote server.

FIG. 1B is a block diagram of a system that implements an intonation model engine on a remote server.

FIG. 2 is a block diagram of an exemplary intonation model engine.

FIG. 3 is a block diagram of an exemplary method for synthesizing intonation.

FIG. 4 is a block diagram of an exemplary method for performing joint learning of segmentation score and shape score.

FIG. 5 illustrates exemplary training utterance information.

FIG. 6 illustrates an exemplary model schematic.

FIG. 7 illustrates an exemplary lattice for an utterance.

FIG. 8 illustrates exemplary syllabic nuclei.

FIG. 9 illustrates a table of features used in segmentation and knot components.

FIG. 10 illustrates another exemplary lattice for an utterance.

FIG. 11 is a block diagram of an exemplary system for implementing the present technology.

### DETAILED DESCRIPTION

The present technology provides a predictive model of intonation that can be used to produce natural-sounding pitch movements for a given text. Naturalness is achieved by constraining fast pitch movements to fall on a subset of the frames in the utterance. The model jointly learns where such pitch movements occur and the extent of the movements. When applied to the text of books and newscasts, the resulting synthetic intonation is found to be more natural than the intonation produced by several state-of-the-art text-to-speech synthesizers.

The intonation model of the present technology, disclosed herein, assigns different words within a sentence to be prominent, analyzes multiple prominence possibilities (in some cases, all prominence possibilities), and learns parameters of the model using large amounts of data. Unlike previous systems, the present system discovers intonation patterns from data. Speech data is sub-segmented into words, the different segments are analyzed and used for learning, and a determination is made as to whether the segmentations predict pitch. Prominence within a sentence may be assigned using word positions and/or prominent syllables of words as markers in time. The markers are linked, indicating what and where the prominence should be, and parameters of the model are learned from large amounts of data. The intonation model described herein may be implemented on a local machine such as a mobile device or on a remote computer such as a back-end server that communicates with a mobile application on a mobile device.

Prior art systems have attempted to segment speech signals and to use selected segments to later learn pitch contours for the segments. This segmentation and pitch contour learning was done in a pipeline fashion, with the pitch contour work performed once segmentation was complete. Prior art systems have not disclosed or suggested any model or functionality that allows for segmentation and pitch learning to be performed simultaneously in parallel. The present technology allows computing systems to operate more efficiently, and save memory, at a minimum, while providing an output which is better than, or at least as good as, the previous systems.

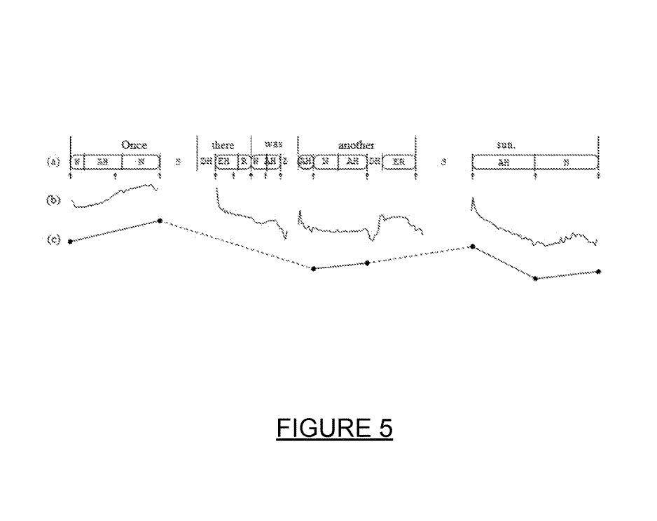

Intonation is easy to measure, but hard to model. Intonation is realized as the fundamental frequency (F0) of the human voice for voiced sounds in speech. It can be measured by dividing an utterance into 5 millisecond frames and inverting the observed period of the glottal cycle at each frame. For frames containing unvoiced speech sounds, F0 is treated as unobserved. FIG. 5 shows an example utterance (a) and its intonation (b).

When F0 is measured in this way and applied during synthesis to the same utterance, the result is completely natural-sounding intonation. However, when intonation is derived from a regression model that has been trained on frame-by-frame examples of F0, it tends to sound flat and lifeless, even when it has been trained on many hours of speech, and even when relatively large linguistic units such as words and syntactic phrases are used as features.

The predictions often lack the variance or range of natural intonations, and subjectively they seem to lack purpose. One possible explanation for this is that perceptually salient pitch movements occur only during certain frames in the utterance, so an effective model may determine which frames are key and will predict pitch values for all frames. This notion is corroborated by linguists that study intonation, who posit that significant pitch movements are centered on syllabic nuclei, such as the example discussed in “The phonology and phonetics of English intonation,” Ph.D. thesis by Janet Pierrehumbert, MIT, 1980. Moreover, they posit that only a subset of the syllabic nuclei in an utterance host significant pitch movements, and that this subset is determined by the phonology, syntax, semantics, and pragmatics of the utterance.

In the intonation model of the present technology, intonation is represented as a piecewise linear function, with knots permissible at syllabic nucleus boundaries (see FIG. 5). FIG. 5 illustrates exemplary training utterance information. In FIG. 5, a training utterance has (a) a phonetic alignment and (b) intonation in the form of log F0 measurements, which are modeled using (c) a piecewise linear function. Knot locations are selected from among permissible locations (arrows) which are derived from syllabic nuclei locations (rounded rectangles). Perceptually salient pitch movements occur over subword spans (solid line segments).

The line segments can be short, subword spans (solid lines) or long, multiword spans (dashed lines). The subword spans tend to coincide with individual syllabic nuclei, and correspond to perceptually salient pitch movements.

To construct the model, we employ a framework that is very common in machine learning. The model is probabilistic, and its parameters are found by maximum likelihood estimation, subject to regularization via a validation set. To learn the intonation habits of an individual person, we obtain a set of utterances spoken by that person and train the model by finding a parameter setting that best explains the relationship between the contents and the intonation of each utterance.

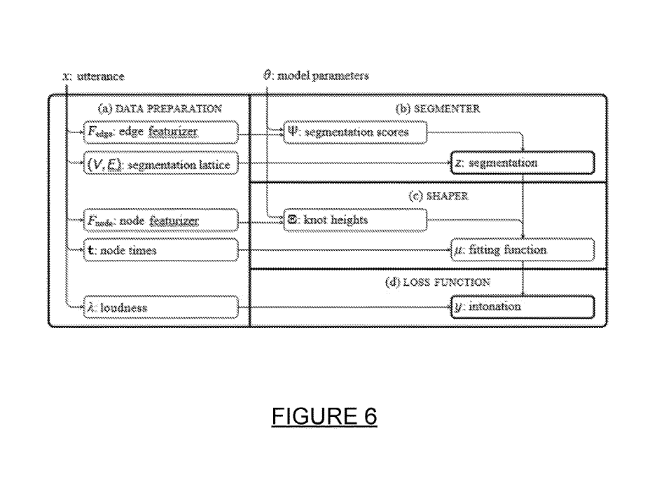

To make sure that the set of utterances were not overfit, the model may be validated using a second set of utterances that serve as the validation set. Constructing the model entails assigning a probability density to an intonation y, conditioned on utterance contents x and a vector of parameters θ. Broadly speaking the model has four components, as diagrammed in FIG. 6.

(a) Data preparation involves the deterministic derivation of input variables from utterance contents x.
(b) A segmenter defines a probability distribution over possible segmentations of the utterance. The segmentation z is a latent variable.
(c) A shaper assigns pitch values to each knot in a segmentation, which induces a fitting function μ(t) from which the intonation is generated.
(d) A loss function governs the relationship between fitting function μ and intonation y

The same model is used for speech analysis and speech synthesis. During analysis, the segmentater and the shaper are trained jointly. The loss function is consulted during analysis, but not during synthesis. In some instances, this model does account for microprosody, an example of which is described in “Analysis and synthesis of intonation using the tilt model,” The Journal of the Acoustical Society of America, 2000, by Paul Taylor, which is the finer-scale fluctuation in pitch that arises from changing aerodynamic conditions in the vocal tract as one sound transitions to another, visible in FIG. 5. Microprosody may allow for intonation to sound natural, but rather than model it, the present technology may simulate it during synthesis, as described below.

Previous work on the predictive modeling of intonation, during analysis, groups adjacent syllables into chunks by fitting a piecewise function to the pitch curve of the utterance being analyzed, so that each chunk corresponds to a segment of the piecewise function. Then a classifier is used to learn segment boundaries, and separately a regression tree is used to learn the parameters that govern the shape of the pitch curve for each segment. At prediction time, the classifier is used to construct segments, and then the regression tree is used to produce a shape for the intonation over each chunk.

The present technology differs from the Accent Group model in several ways. Chunking and shaping are trained jointly, so the present model can be trained directly on a loss function that compares observed and predicted pitch values. The segmentations for the training utterances remain latent and are summed over during training, which frees the model to find the best latent representation of intonational segments. The loss function of the present model gives more weight to loud frames, to reflect the fact that pitch is more perceptually salient during vowels and sonorants than during obstruents. Pitch values of the present model are fit using a different class of functions. The Accent Group model uses the Tilt model, where log F0 is fit to a piecewise quadratic function, an example of which is described in “Analysis and synthesis of intonation using the tilt model,” The Journal of the Acoustical Society of America, 2000, by Paul Taylor. The knots of the piecewise function are aligned to syllable boundaries. The present technology also uses a piecewise linear function, and the knots are aligned to syllable nucleus boundaries.

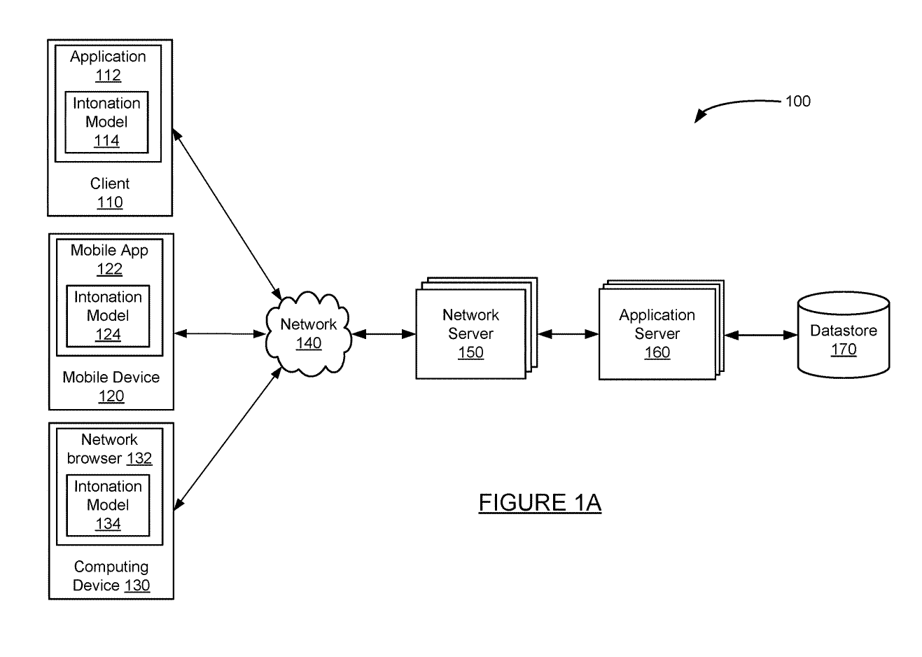

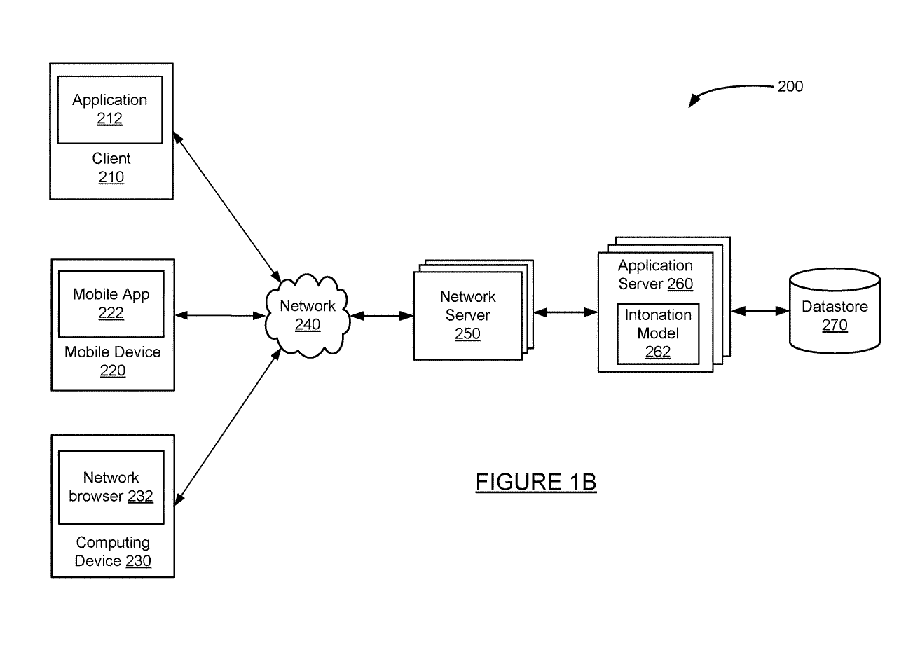

FIG. 1A is a block diagram of a system that implements an intonation model engine on a computer. System 100 of FIG. 1A includes client 110, mobile device 120, computing device 130, network 140, network server 150, application server 160, and data store 170. Client 110, mobile device 120, and computing device 130 communicate with network server 150 over network 140. Network 140 may include a private network, public network, the Internet, and intranet, a WAN, a LAN, a cellular network, or some other network suitable for the transmission of data between computing devices of FIG. 1A.

Client 110 includes application 112. Application 112 may provide speech synthesis and may include intonation model 114. Intonation model 114 may provide a latent-segmentation model of intonation as described herein. The intonation model 114 may assign different words within a sentence to be prominent, analyzes multiple prominence possibilities (in some cases, all prominence possibilities), and learns parameters of the model using large amounts of data. Intonation model 114 may communicate with application server 160 and data store 170, through the server architecture of FIG. 1A or directly (not illustrated in FIG. 1) to access the large amounts of data.

Network server 150 may receive requests and data from application 112, mobile application 122, and network browser 132 via network 140. The request may be initiated by the particular applications or browser or by intonation models within the particular applications and browser. Network server 150 may process the request and data, transmit a response, or transmit the request and data or other content to application server 160.

Application server 160 may receive data, including data requests received from applications 112 and 122 and browser 132, process the data, and transmit a response to network server 150. In some implementations, the responses are forwarded by network server 152 to the computer or application that originally sent a request. Application's server 160 may also communicate with data store 170. For example, data can be accessed from data store 170 to be used by an intonation model to determine parameters for a sentence or other set of words marked with prominences.

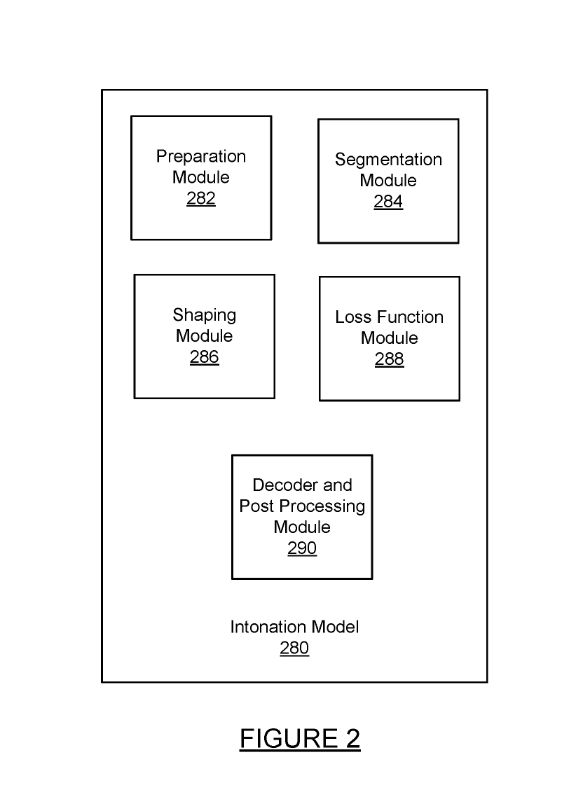

FIG. 1B is a block diagram of a system that implements an intonation model engine on a remote server. System 200 of FIG. 2 includes client 210, mobile device 220, computing device 230, network 240, network server 250, application server 260, and data store 270. Client 210, mobile device 220, and computing device 230 can communicate with network server 250 over network 240. Network 240, network server 250, and data store 270 may be similar to network 140, network server 150, and data store 170 of system 100 of FIG. 1. Client 210, mobile device 220, and computing device 230 may be similar to the corresponding devices of system 100 of FIG. 1, except the devices may not include an intonation model.

Application server 260 may receive data, including data requests received from applications 212 and 222 and browser 232, process the data, and transmit a response to network server 250. In some implementations, the responses are forwarded by network server 252 the computer or application that originally sent a request. In some implementations, network server 250 and application server to 60 are implemented on the same machine. Application server 260 may also communicate with data store 270. For example, data can be accessed from data store 270 to be used by an intonation model to determine parameters for a sentence or other set of words marked with prominences.

Application server 260 may include intonation model 262. Similar to the intonation models in the devices of system 100, intonation model 262 may provide speech synthesis and may include intonation model 214. Intonation model 262 may provide a latent-segmentation model of intonation as described herein. The intonation model 262 may assign different words within a sentence to be prominent, analyzes multiple prominence possibilities (in some cases, all prominence possibilities), and learn parameters of the model using large amounts of data. Intonation model 262 may communicate with application 212, mobile application 222, and network browser 232. Each of application 212, mobile application 222, and network browser 232 may send and receive data from intonation model 262, including receiving speech synthesis data to output on corresponding devices client 210, mobile device 220, and computing device 230.

FIG. 2 is a block diagram of an exemplary intonation model engine. Intonation Model engine 280 includes preparation module 282, segmentation model 284, shaping module 286, and decoder and post processing module 288. Preparation module 282 may prepare data as part of model construction. In some instances, the data preparation may include the deterministic derivation of input variables from utterance contents. Segmentation module 284 may, in some instances, define a probability distribution over the possible segmentations of an utterance. Shaping module 286 may assign pitch values to each knot in a segmentation. The pitch value assignment may induce a fitting function from which an intonation is generated. A loss function module 288 governs a relationship between the fitting function and intonation. A decoder and post processing module 290 may perform decoding and post processing functions.

Though the intonation model engine is illustrated with four modules 282-288, more or fewer modules may be included. Further, though the modules are described as operating to provide or construct the intonation module, other functionality described herein may also be performed by the modules. Additionally, all or part of the intonation module may be located on a single server or distributed over several servers.

The intonation model can provide speech synthesis as part of a conversational computing tool. Rather than providing short commands to the application for processing, a user may simply have a conversation with the mobile device interface to express what the user wants. The conversational computing tool can be implemented by one or more applications, implemented on a mobile device of the user, on remote servers, and/or distributed in more than one location, that interact with a user through a conversation, for example by texting or voice. The application(s) may receive and interpret user speech or text, for example through a mobile device microphone or touch display. The application can include logic that then analyzes the interpreted speech or text and perform tasks such as retrieve information related to the input received from the user. For example, if the user indicated to the executing application that the user wanted to purchase a TV, the application logic may ask the user if she wants the same TV as purchased before, ask for price information, and gather additional information from a user. The application logic can make suggestions based on the user speech and other data obtained by the logic (e.g., price data). In each step of the conversation, the application may synthesize speech to share what information the application has, what information the user may want (suggestions), and other conversations. The application may implement a virtual intelligent assistant that allows users to conduct natural language conversations to request information, control of a device, or perform tasks. By allowing for conversational artificial intelligence to interact with the application, the application represents a powerful new paradigm, enabling computers to communicate, collaborate, understand our goals, and accomplish tasks.

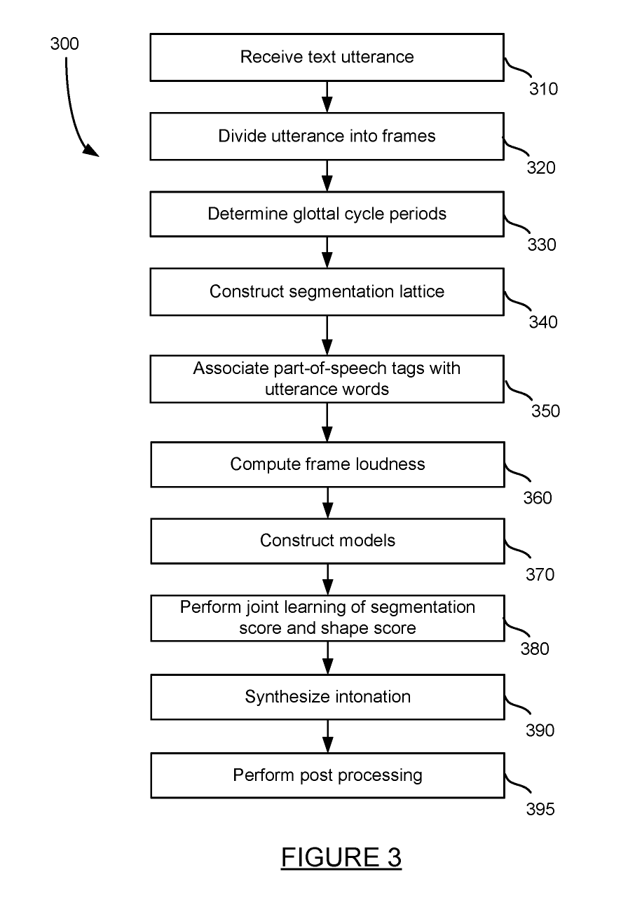

FIG. 3 is a block diagram of an exemplary method for synthesizing intonation. The method of FIG. 3 may be performed by an intonation model implemented in a device in communication with an application server over a network, at an application server, or a distributed intonation model which is located at two or more devices or application servers.

A text utterance may be received by the intonation model at step 310. The text utterance may be received as an analog audio signal from a user, written text, or other content that includes information regarding words in a particular language. The utterance may be divided into frames at step 320. The frames may be used to analyze the utterance, such that a smaller frame provides finer granularity but requires more processing. In some instances, a frame may be a time period of about five (5) milliseconds. A period of a glottal cycle may be determined at each frame at step 330. In some instances, the period of glottal cycle may be inverted after it is determined.

A segmentation lattice may be constructed at step 340. The words of the utterance may be analyzed to construct the segmentation lattice. In some instances, each word may have three nodes. The words may be analyzed to identify node times for each word. In some instances, a word may have a different number of nodes.

Utterance words may be associated with part-of-speech tags at step 350. Associating the utterance words may include parsing the words for syntax and computing features for each word. The loudness of each frame may be computed at step 360. The loudness may be computed at least in part based on the acoustic energy of the frame and applying time-adaptive scaling.

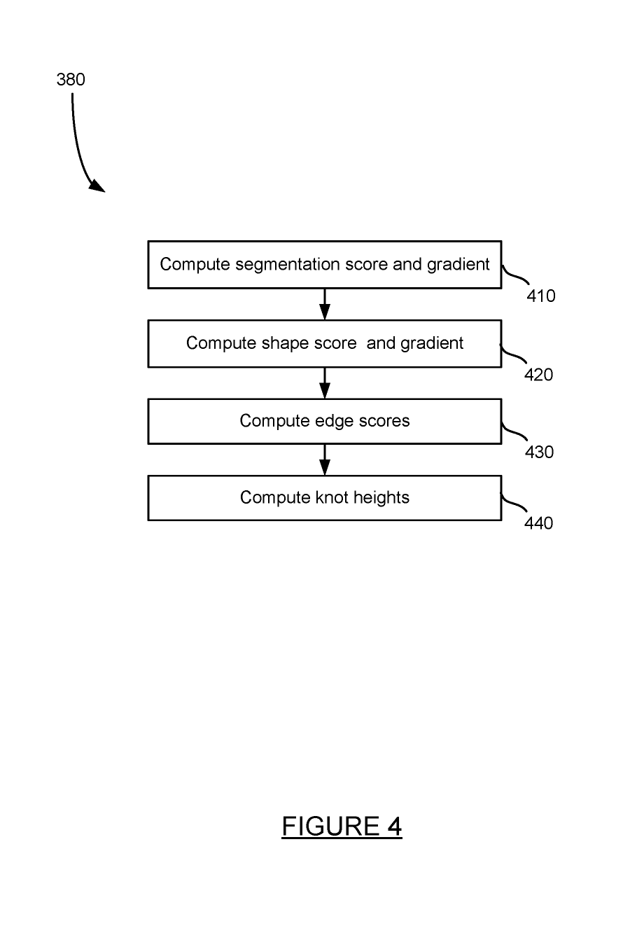

Models may be constructed at step 370. Constructing a model may include assigning a probability density to the intonation conditioned on utterance contents and a vector of parameters. The intonation model may then jointly perform learning of segmentation score and shape score at step 380. Unlike systems of the prior art, the segmentation and shaping is performed jointly (e.g., at the same time). This is contrary to systems of the prior art which implement a ‘pipeline’ system that first determines a segment and then processes the single segment in an attempt to determine intonation. Details for jointly learning segmentation score and shaping score is discussed in FIG. 4.

Intonation may be synthesized at step 390. Synthesizing intonation may include performing Viterbi decoding on a lattice to find modal segmentation. The modal segmentation may then be plugged into a fitting function. Post processing may be performed at step 395. The post processing may include smoothing the decode result with a filter, such as for example a triangle (Bartlett) window filter.

Each step in the method of FIG. 3 is discussed in more detail below.

FIG. 4 is a block diagram of an exemplary method for performing joint learning of segmentation score and shape score. The method of FIG. 4 provides more detail for step 380 of the method of FIG. 3. A segmentation score and gradient are computed at step 410. A shape score and gradient are computed at step 420. The segmentation score and shape score and gradients may be computed jointly rather than serially. Edge scores may be computed at step 430. Knot heights may then be computed at step 440. Each step in the method of FIG. 4 is discussed in more detail below.

In operation, the intonation model engine may access training and validation data, and segment the data into sentences. The intonation model may phonetically align the sentences and extract pitch.

Prior to training or prediction, the words of an utterance are analyzed to construct a segmentation lattice, which is an acyclic directed graph (V, E) that represents the possible segmentations of an utterance. The nodes in node set V are numbered from 1 to |V|, with the first and last nodes designated as start and end nodes, respectively. The nodes are in topological order, so that j<k for any edge j→k in the edge set E.

Assigned to each node i is a time ti in the utterance, with t1=0 and t|V|=T, where T is the time, in number of frames, at the end of the utterance. Multiple nodes can be assigned the same time, but it may be the case that if j<k, then tj≦tk. Thus, any path through the lattice (from the start node to the end node) yields a sorted sequence of utterance times, which may serve as knot times in a piecewise-linear model of utterance intonation.

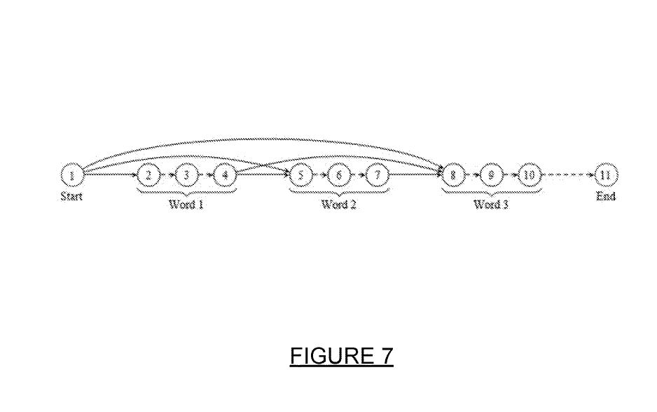

In some instances, the lattice can be made arbitrarily complex, based on a designer's preference (e.g., to capture one's intuitions about intonation). For concreteness, an exemplary embodiment is described of a lattice where there are three nodes for each word, and either all are used as knots, or none are (see FIG. 7). FIG. 7 illustrates an exemplary lattice for an utterance. (Other lattice configurations, with more or fewer nodes for each word, may be used). Formally, for an utterance of m words, the segmentation graph contains 3m+2 nodes. Nodes 1 and 3m+2 are the start and end nodes, and 2, . . . , 3m+1 correspond to the words. The edge set consists of edges within words, between words, from the start and an edge to the end. Edges within words, for each word i, include (3i−1→3i) and (3i→3i+1). Edges between words, for any two words i and j where i<j, include (3i+1→3j−1). Edges from the start, for each word i, include (1→3i−1). An edge to the end may include (3m+1→3m+2).

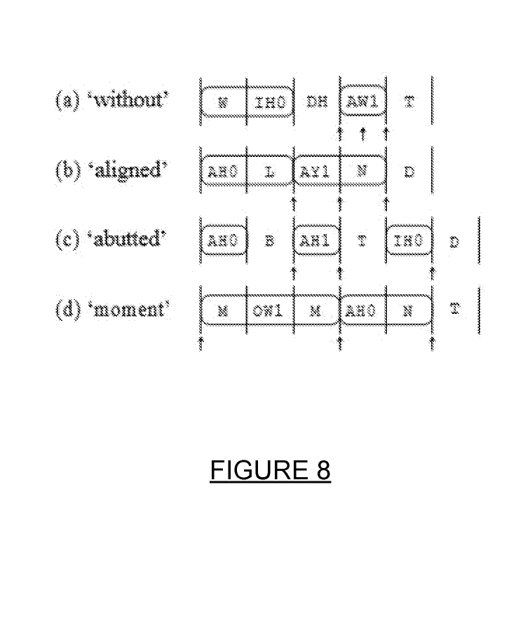

The words of the utterances are analyzed to identify node times, which are defined in terms of the syllabic nuclei in each word. For this purpose, a syllable nucleus consists of a vowel plus any adjacent sonorant (Arpabet L M N NG R W Y). A sonorant between two vowels is grouped with whichever vowel has greater stress. If a word has ultimate stress (i.e. its last syllable has the most prominent stress) it induces node locations at the left, center, and right of the nucleus of the stressed syllable. If a word has non-ultimate stress, it induces node locations at the left and right of the nucleus of the stressed syllable, and also at the right of the nucleus of the last syllable. Examples of syllabic nuclei are illustrated in FIG. 8.

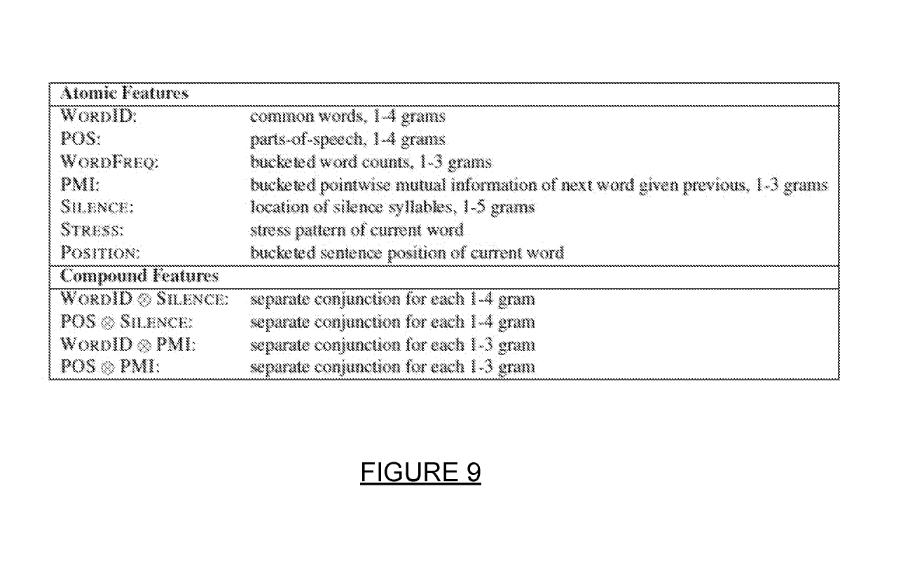

Prior to training or prediction, the words of the utterance are labeled with part-of-speech tags and parsed for syntax. Features are then computed for each word. The table in FIG. 9 lists the atomic and compound features that may be computed.

A word featurizer F (x, i) returns a vector that represents the features of word i in utterance x. An atomic featurizer returns a vector that is a one-shot encoding of a single feature value. For example, the FCAP featurizer returns three possible values, denoting no capitalization, first-letter capitalization, and other:

FCAP(The cat meowed., 2)=(1, 0, 0)^{T}.
FCAP(The Cat meowed., 2)=(0, 1, 0)^{T}.
FCAP(The CAT meowed., 2)=(0, 0, 1)^{T}.

A featurizer can account for the context of a word by studying the entire utterance. For example, the PUNC feature gives the same value to every word in a sentence, but changes depending on whether the sentence ends in period, question mark, or something else.

FPUNC(The cat meowed., 2)=(1, 0, 0)^{T}.
FPUNC(The cat meowed?, 2)=(0, 1, 0)^{T}.
FPUNC(The cat meowed!, 2)=(0, 0, 1)^{T}.

Atomic featurizers can be composed into compound featurizers. Their values are combined via the Kronecker product.

(FCAP [symbol] FPUNC)(The cat meowed., 2)=(1, 0, 0, 0, 0, 0, 0, 0, 0)^{T}.
(FCAP [symbol] FPUNC)(The cat meowed?, 2)=(0, 1, 0, 0, 0, 0, 0, 0, 0)^{T}.
(FCAP [symbol] FPUNC)(The CAT meowed!, 2)=(0, 0, 0, 0, 0, 0, 0, 0, 1)^{T}.

Featurizers can also be concatenated:

(FCAP⊕FPUNC)(The cat meowed., 2)=(1, 0, 0, 1, 0, 0)^{T}.
(FCAP⊕FPUNC)(The cat meowed?, 2)=(0, 1, 0, 1, 0, 0)^{T}.
(FCAP⊕FPUNC)(The CAT meowed!, 2)=(0, 0, 1, 0, 0, 1)^{T}.

The present disclosure uses the expression ⊕ for the concatenation of vectors and also for featurizers that concatenate; for featurizers F and G, (F⊕G)(x, i)=F (x, i)⊕G(x, i). Similarly, (F [symbol] G)(x, i)=F (x, i) [symbol] G(x, i).

Two word featurizers can be defined: FATOMIC is a concatenation of just the atomic featurizers in the table of FIG. 9; FALL is FATOMIC concatenated with the compound featurizers. In order to perform segmentation, the intonation model needs a featurization of edges in the lattice. If the lattice previously discussed is used, an edge featurizer Fedge can be defined in terms of the word featurizer FALL by adding together the features from non-final words. For edge j→k, let

$${F}_{edge} ( x , j , k ) = \{ {\sum }_{i = j}^{k - 1} {F}_{ALL} ( x , i ) \} ⊕ {F}_{ALL} ( x , k ) .$$

In order to model knot heights, the intonation model may use a featurization of nodes in the lattice as well. If the lattice is defined in the previous section, a node featurizer Fnode may be defined in terms of the word featurizer FALL by composing it with a one-shot vector that indicates the node's position in the word. For the nth node of word m, the node number is i=3m+n−2, and let Fnode(x, i)=FALL(x, m) [symbol] FONE-SHOT(n). To keep matters simple, let the start and end nodes have the same featurization as nodes 2 and 3m+1 such that Fnode(x, 1)=Fnode(x, 2), and Fnode(x, 3m+2)=Fnode(x, 3m+1).

The present system computes the loudness of each frame by computing its acoustic energy in the 100-1200 Hz band and applies time-adaptive scaling so that the result is 1 for loud vowels and sonorants; 0 for silence and voiceless sounds; close to 0 for voiced obstruents; and some intermediate value for softly-articulated vowels and sonorants. In some instances, the present system represents loudness with a piecewise-constant function of time λ(t) whose value is the loudness at frame [t].

Loudness can be used as a measure of the salience of the pitch in each frame. In some instances, the present system may not expend model capacity on modeling the pitch during voiced obstruent sounds because they are less perceptually salient, and because the aerodynamic impedance during these sounds induces unpredictable microprosodic fluctuations. The present model represents intonation with a piecewise-constant function of time y(t) whose value is the log F0 at frame [t].

A basic version of the intonation model may be used in which segmentations and intonation shapes are based on weighted sums of edge and node feature vectors. The intonation model is a probablistic generative model in which utterance content x generates a segmentation z, and together they generate intonation y:

$$P ( z , y \vert x , θ ) = \underbrace{P ( z \vert x , θ )}_{segmenting} \underbrace{P ( y \vert z , x , θ )}_{shaping + loss} .$$

Utterance content x encompasses all the elements derived from an individual utterance, as described herein. To recap, this includes the segmentation lattice (V, E); node times t=(t1, . . . , t|V|); edge and node featurizations Fedge and Fnode; and loudness measurements λ(t). Model parameters are collected in a vector θ, which in the basic model is the concatenation of two vectors θ=θedge⊕θnode, where θedge and θnode are the same lengths as the feature vectors returned by Fedge and Fnode, respectively. Since segmentation z is a hidden variable, an expression for the marginal probability P (y|x, θ) can be derived as discussed below.

To assign a probability to each segmentation, we assign a segmentation score φj→k to each edge (j→k)εE of the segmentation lattice:

φ_{j→k}=θ_{edge}^{T}F_{edge} [symbol] F_{ALL} [symbol] (x,j,k). (1)

### Then,

$$P ( z \vert x , θ ) = \frac{{\prod }_{j \to k ∈ z} exp ( {ψ}_{j \to k} )}{ {\prod }_{j \to k ∈ {z}^{′}} exp ( {ψ}_{j \to k} )} ,$$

Where 3 is the set of all paths in the lattice that go from the start node to the end node.
A probability density for intonation y(t) is defined by comparing it to a fitting function μ(t) via a weighted L2 norm:

$$P ( y \vert z , x , θ ) = \frac{1}{H} exp {\int }_{0}^{T} - {λ ( t ) [ y ( t ) - μ ( t ) ]}^{2} dt .$$

When λ(t)=0 (as for voiceless frames), y(t) can take any value without affecting computations. The fitting function μ(t) is a piecewise linear function that interpolates between coordinates (ti, ξi) for nodes i in path z, as depicted in FIG. 5. In the basic model, the knot height for node i is

ξᵢ=θ_{node}^{T}F_{node} [symbol] F_{ALL} [symbol] (x,i).

The normalizer H is constant with respect to θ and z.

Expanding the equation:

$$P ( y \vert x , θ ) = P ( y \vert z , x , θ ) P ( z \vert x , θ )$$

results in an unwieldy expression. However, if we define

φ_{i→j}=∫ₜ_{ᵢ}^{t}^{ⱼ}−λ(t)[y(t)−μ(t)]²dt, (3)

then

$$P ( y \vert z , x , θ ) = \frac{1}{H} exp {\sum }_{j \to k ∈ z} {φ}_{j \to k} .$$

Exploiting the fact that P (y|z, x, θ) and P (z|x, θ) now have the same structure, we get

$$P ( y \vert x , θ ) = \frac{{\sum }_{z ∈ 3}^{ } {\prod }_{j -> k ∈ z}^{ } exp ( {ψ}_{j -> k} + {φ}_{j -> k} )}{H {\sum }_{z ∈ 3}^{ } {\prod }_{j -> k ∈ z}^{ } exp ( {ψ}_{j -> k} )} . \qquad ( 4 )$$

The goal of learning is to find model parameters θ that maximize

$$L ( θ ) = \{ {\sum }_{u}^{ } log P ( {y}^{( u )} \vert {x}^{( u )} , θ ) \} - κ {‖ θ ‖}_{2}^{2} ,$$

which is the log likelihood of the model, subject to regularization on θ. The sum is over all training utterances, here indexed by u. The regularization constant κ is to be tuned by hand. We find argmaxθ L(θ) via first-order optimization, so we have to compute L(θ) and its gradient

$${∇}_{θ} L ( θ ) = \{ {\sum }_{u}^{ } {∇}_{θ} log P ( {y}^{( u )} \vert {x}^{( u )} , θ ) \} - 2 κθ .$$

Now we return to considering just one utterance as discussed above and show how to compute log P (y|x, θ) and ∇θ log P (y|x, θ). By the chain rule, this entails several steps, starting with computing log P (y|x, θ) and its gradient in terms of edge scores components φj→k and φj→k and their gradients. For each edge (j→k)εE, compute φj→k and ∇θφj→k in terms of knot heights ξj and ξk and their gradients. For each edge (j→k)εE, compute edge score φj→k via Eq. 1. The gradient ∇θφj→k is straightforward. For each node iεV, compute the corresponding knot height ξi via Eq. 2. The gradients ∇θξi is straightforward.

In the expression for P (y|x, θ) in Eq. 4, both numerator and denominator have the form

$$s {=}^{Δ} {\sum }_{z ∈ 3}^{ } {\prod }_{( j -> k ) ∈ z}^{ } {c}_{j , k} ,$$

where cj,k is an arbitrary function of θ that is associated with edge j→k. Here we show how to compute s and its gradient, as this is the main difficulty of computing log P (y|x, θ) and its gradient.

We can compute s in ◯(|V|+|ε|) time using a recurrence relation.

Let 3 (j, k) be the set of all paths in (V, ε) that go from j to k, and let a forward sum be defined as

$${a}_{i} = {\sum }_{z ∈ 3 ( 1 , i )}^{ } {\prod }_{( j -> k ) ∈ z}^{ } {c}_{j , k} .$$

The following recurrence holds

$${a}_{k} = {\sum }_{( j -> k ) ∈ l}^{ } {c}_{j , k} {a}_{j} .$$

The sum is over all edges that lead to node k. The desired result is s=a|V|.
To compute ∇θs, we use a method where backward sums are used in conjunction with forward sums. Let a backward sum be defined as

$${b}_{i} = {\sum }_{z ∈ 3 ( i , \vert V \vert )}^{ } {\prod }_{( j -> k ) ∈ z}^{ } {c}_{j , k} .$$

The following recurrence holds

$${b}_{j} = {\sum }_{( j -> k ) ∈ ℰ} {c}_{j , k} {b}_{k} .$$

The sum is over all edges that lead from node j. This recurrence must be evaluated in reverse order, starting from b|V|. The gradient is obtained via

$${∇}_{θ} s = {\sum }_{( j -> k ) ∈ ℰ} {a}_{j} ( {∇}_{θ} {c}_{j , k} ) {b}_{k} .$$

Eq. 3 clouds the fact that φj→k is a function of knot heights ξj and ξk, which makes it hard to see how their gradients are related. We define basis functions

$${a}_{j , k} ( t ) = \{ \begin{matrix}( {t}_{k} - t ) / ( {t}_{k} - {t}_{j} ) & for {t}_{j} \leq t < {t}_{k} , \\ 0 & otherwise\end{matrix} , \\ {b}_{j , k} ( t ) = \{ \begin{matrix}( t - {t}_{j} ) / ( {t}_{k} - {t}_{j} ) & for {t}_{j} \leq t < {t}_{k} , \\ 0 & otherwise\end{matrix} .$$

And restate the fitting function as

$$μ ( t ) = {\sum }_{( j -> k ) ∈ z} {ξ}_{j} {a}_{j , k} ( t ) + {ξ}_{k} {b}_{j , k} ( t ) , \qquad ( 5 )$$

### Whence:

φ_{j→k}=−∫ₜ_{ⱼ}^{t}^{ₖ}λ(t)[y(t)−ξⱼa_{j,k}(t)−ξⱼb_{j,k}(t)]²dt.

For algebraic tractability we restate φj→k in terms of inner products. For real-valued functions of time α(t), β(t), and γ(t), the weighted inner product is defined as

(α,β)_{γ}=∫₀^{T}γ(t)α(t)β(t)dt.

### Then,

$${φ}_{j -> k} = - {〈 y , y 〉}_{λ} + 2 {ξ}_{j} {〈 {a}_{j , k} , y 〉}_{λ} + 2 {ξ}_{k} {〈 {b}_{j , k} , y 〉}_{λ} - {ξ}_{j}^{2} {〈 {a}_{j , k} , {a}_{j , k} 〉}_{λ} - {ξ}_{k}^{2} {〈 {b}_{j , k} , {b}_{j , k} 〉}_{λ} + 2 {ξ}_{j} {ξ}_{k} {〈 {a}_{j , k} , {b}_{j , k} 〉}_{λ} .$$

The gradient follows directly:

$${∇}_{θ} {φ}_{j -> k} = 2 {∇}_{θ} {ξ}_{j} {〈 {a}_{j , k} , y 〉}_{λ} + 2 {∇}_{θ} {ξ}_{k} {〈 {b}_{j , k} , y 〉}_{λ} - 2 {ξ}_{j} {∇}_{θ} {ξ}_{j} {〈 {a}_{j , k} , {a}_{j , k} 〉}_{λ} - 2 {ξ}_{k} {∇}_{θ} {ξ}_{k} {〈 {b}_{j , k} , {b}_{j , k} 〉}_{λ} + 2 {ξ}_{j} {∇}_{θ} {ξ}_{k} {〈 {a}_{j , k} , {b}_{j , k} 〉}_{λ} + 2 {ξ}_{k} {∇}_{θ} {ξ}_{j} {〈 {a}_{j , k} , {b}_{j , k} 〉}_{λ} .$$

All of the inner products can be precomputed for faster learning.

Once optimal parameters θ′ have been found, intonation can be synthesized by doing Viterbi decoding on the lattice to find the modal segmentation

$${z}^{*} = arg max {log}_{z} P ( z \vert x , {θ}^{*} )$$

and plugging that into Eq. 5 to get the conditional modal intonation

$${y}^{*} = {arg max}_{y} log P ( y \vert {z}^{*} , x , {θ}^{*} ) . \vert$$

Since it is possible for multiple knots have the same knot times, the decode result y* could be a discontinous function of time. If this discontinuity in the synthesized intonation is over voiced frames, the result is subjectively disagreeable. To preclude this, we smooth the decode result with a triangle window filter that is 21 frames long.

The synthesized intonation curve is further processed to simulate microprosody. We do this by adding in the loudness curve λ(t) to effect fluctionations in the intonation curve that are on the order of a semitone in amplitude.

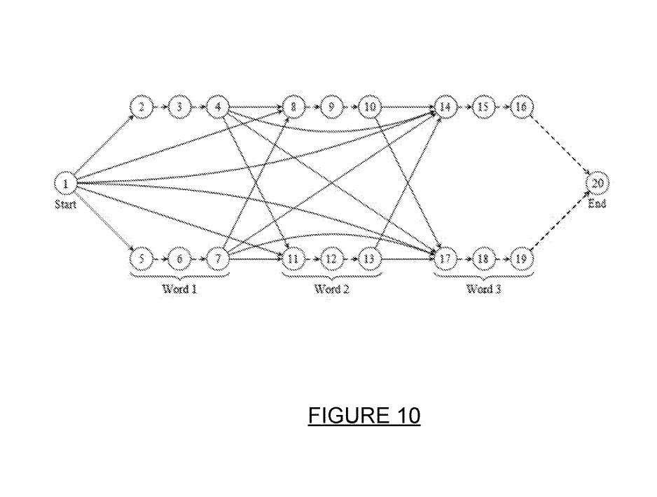

There may be two or more generalizations to the present model. In a first generalization, the segmentation lattice (V, ε) can be made arbitrarily elaborate, as long as the featurizers Fedge and Fnode are updated to give a featurization of each edge and node. For example, there could be 6 nodes per word as shown in FIG. 10 to permit the model to learn two ways of intoning each word.

In another generalization, in the basic model, edge scores Ψ=(φe|eεε) and knot heights Ξ=(ξ1, . . . , ε|V|) were linear combinations of the feature vectors, as described in Eqs. 1 and 2. In a general model, they can be any differentiable function of the feature vectors. In particular, they can be parameterized in a non-linear fashion, as the output of a neural net. So long as the gradients of the knot heights ∇θξi and segment scores ∇θφe in terms of neural net parameters θ can be computed efficiently, the gradient of the full marginal data likelihood with respect to θ can be computed efficiently via the chain rule and the model can be trained as before. This observation covers many potential architectures for the neural parameterization.

The full vector of all knot heights Ξ and the full set of segment scores Ψ can be parameterized jointly as a function of the full input sequence x: (Ξ, Ψ)=h(θ, x), where h is a non-linear function parameterized by θ that maps the input x to knot heights Ξ and segment scores Ψ. If ∇θh(θ, x) can be computed tractably, learning in the full model is tractable. Several neural architectures fit this requirment. First, nonrecurrent feed-forward and convolutional neural networks, such as those described in “Advances in neural information processing systems,” by Alex Krizhevsky, Ilya Sutskever, and Geoffrey E Hinton, 2012, that generate each ξi and φe from local contexts can achieve the same effect as many of the hand-crafted features discussed earlier. More sophisticated networks can also be used to captures non-local contexts—for example, basic recurrent neural networks (RNN), and example of which is described in “Recurrent neural network based language model,” INTER-SPEECH, volume 2, 2010, or bidirectional long short-term memory networks (LSTM), an example of which is described in “Long short-term memory,” Neural computation, 1997, by Hochreiter and Schmidhuber.

After training the model on the dataset discussed above and then predicting pitch on the held-out development set, the prosodic curves predicted by our model sound substantially more natural than conventional models and exhibit naturally higher pitch variance.

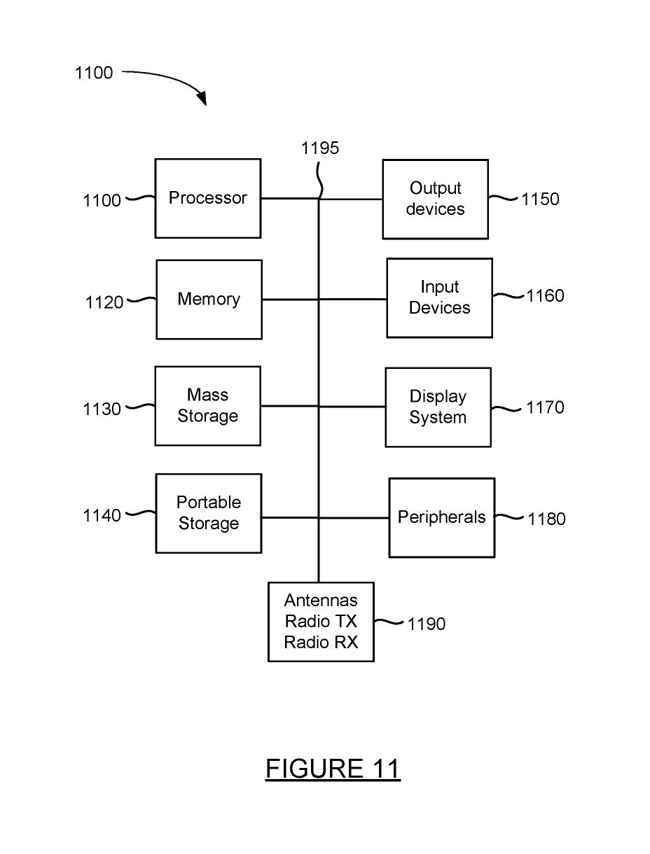

FIG. 11 is a block diagram of a computer system 400 for implementing the present technology. System 1100 of FIG. 11 may be implemented in the contexts of the likes of client 110 and 210, mobile device 120 and 220, computing device 130 and 230, network server 150 and 250, application server 160 and 260, and data stores 170 and 180.

The computing system 1100 of FIG. 11 includes one or more processors 1110 and memory 1120. Main memory 1120 stores, in part, instructions and data for execution by processor 1110. Main memory 1110 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1190. However, the components may be connected through one or more data transport means. For example, processor unit 1110 and main memory 1120 may be connected via a local microprocessor bus, and the mass storage device 1130, peripheral device(s) 1180, portable or remote storage device 1140, and display system 1170 may be connected via one or more input/output (I/O) buses.

Mass storage device 1130, which may be implemented with a magnetic disk drive or an optical disk drive, is a non-volatile storage device for storing data and instructions for use by processor unit 1110. Mass storage device 1130 can store the system software for implementing embodiments of the present invention for purposes of loading that software into main memory 620.

Portable storage device 1140 operates in conjunction with a portable non-volatile storage medium, such as a compact disk, digital video disk, magnetic disk, flash storage, etc. to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, or a pointing device, such as a mouse, a trackball, stylus, or cursor direction keys. Additionally, the system 1100 as shown in FIG. 11 includes output devices 1150. Examples of suitable output devices include speakers, printers, network interfaces, and monitors.

Display system 1170 may include a liquid crystal display (LCD), LED display, touch display, or other suitable display device. Display system 1170 receives textual and graphical information, and processes the information for output to the display device. Display system may receive input through a touch display and transmit the received input for storage or further processing.

Peripherals 1180 may include any type of computer support device to add additional functionality to the computer system. For example, peripheral device(s) 1180 may include a modem or a router.

The components contained in the computer system 1100 of FIG. 11 can include a personal computer, hand held computing device, tablet computer, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Apple OS or iOS, Android, and other suitable operating systems, including mobile versions.

When implementing a mobile device such as smart phone or tablet computer, or any other computing device that communicates wirelessly, the computer system 1100 of FIG. 11 may include one or more antennas, radios, and other circuitry for communicating via wireless signals, such as for example communication using Wi-Fi, cellular, or other wireless signals.

What is claimed is:

1. A method for performing speech synthesis, comprising:
receiving, by an application on a computing device, data for a collection of words;
marking one or more of the collection of words with prominence data by the application;
determining parameters based on the prominence data; and
generating by the application synthesized speech data based on the determined parameters.

2. The method of claim 1, further comprising marking, by the application on the computing device, one or more syllables of the words with prominence data.

3. The method of claim 2, wherein the syllables are prominent syllables.

4. The method of claim 1, further comprising assigning one or more of the parameters to a word of the collection of words.

5. The method of claim 1, wherein the computing device includes a mobile device, the application including a mobile application in communication with remote server.

6. The method of claim 1, wherein the computing device includes a server, the server in communication with a mobile device.

7. A non-transitory computer readable medium for performing speech synthesis, comprising:
receiving, by an application on a computing device, data for a collection of words;
marking one or more of the collection of words with prominence data by the application;
determining parameters based on the prominence data; and
generating by the application synthesized speech data based on the determined parameters.

8. The non-transitory computer readable medium of claim 7, further comprising marking, by the application on the computing device, one or more syllables of the words with prominence data.

9. The non-transitory computer readable medium of of claim 8, wherein the syllables are prominent syllables.

10. The non-transitory computer readable medium of claim 7, further comprising assigning one or more of the parameters to a word of the collection of words.

11. The non-transitory computer readable medium of claim 7, wherein the computing device includes a mobile device, the application including a mobile application in communication with remote server.

12. The non-transitory computer readable medium of claim 7, wherein the computing device includes a server, the server in communication with a mobile device.
